(19) United States
(12) Patent Application Publication
(10) Pub. No.: US 2026/0054823 A1
(43) Pub. Date: Feb. 26, 2026

(54) TRUSS-BRACED WING AIRCRAFT ENGINE MOUNTING AND ASSOCIATED SYSTEMS

(71) Applicant: General Electric Company, Evendale, OH (US)

(72) Inventors: Eric Barre, Evendale, OH (US); Brandon W. Miller, West Chester, OH (US)

(21) Appl. No.: 18/812,765

(22) Filed: Aug. 22, 2024

(51) Int. Cl. B64C 3/34; B64C 3/18

(52) U.S. Cl. CPC B64C 3/18; B64D 27/18

(57) ABSTRACT

Truss-braced wing aircraft engine mounting and associated systems are disclosed. An example aircraft includes a fuselage including a central structural section, a wing extending from the fuselage, a truss extending from the central structural section and coupled to the wing, a pylon coupled to the central structural section, and an engine coupled to the pylon, wherein the pylon is positioned at an angle substantially 45 degrees from a horizontal plane and a vertical plane.

### FIELD OF THE DISCLOSURE

This disclosure relates generally to aircraft systems and, more particularly, to truss-braced wing aircraft engine mounting and associated systems.

### BACKGROUND

A conventional commercial aircraft generally includes a fuselage, a pair of wings, and a propulsion system that provides thrust. The propulsion system typically includes one or more aircraft engines, such as turbofan jet engines. The aircraft engine(s) may be typically mounted to a respective one of the wings of the aircraft, such as in a suspended position beneath the wing. Aircraft engine(s) often utilize an air turbine starter to produce mechanical power that can initiate rotation of other engine components during startup.

### BRIEF DESCRIPTION OF THE DRAWINGS

FIG. 1 is a schematic representation of an example aircraft in accordance with examples disclosed herein.

FIG. 2 is a schematic representation of another example aircraft in accordance with examples disclosed herein.

FIG. 3 is a side-view of the example aircraft of FIG. 1 and/or the example aircraft of FIG. 2.

FIG. 4 is a schematic representation of another example aircraft in accordance with examples disclosed herein.

FIG. 5 is a side-view of the example aircraft of FIG. 4.

FIG. 6 is a schematic representation of another example aircraft in accordance with examples disclosed herein.

FIG. 7 is a schematic representation of another example aircraft in accordance with examples disclosed herein.

In general, the same reference numbers will be used throughout the drawing(s) and accompanying written description to refer to the same or like parts. The figures are not necessarily to scale.

### DETAILED DESCRIPTION

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B.

As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. Further, in the context of an aircraft and associated structures, the terms “above” and “below” are relative to a normal operational attitude of the aircraft during ground and/or cruise operations. For example, during ground operations, landing gear of an aircraft is positioned below the fuselage of the aircraft.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

The terms “forward” and “aft” refer to relative positions within a turbine engine or aircraft, and refer to the normal operational attitude of the turbine engine or aircraft. For example, with regard to an aircraft, forward refers to a position closer to a nose of the aircraft and aft refers to a position closer to a tail of the aircraft. Further, with regard to a turbine engine, forward refers to a position closer to an engine inlet and aft refers to a position closer to an engine nozzle or exhaust.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. Specifically, as used herein in the context of describing the position and/or orientation of an object relative to another object and/or a plane (i.e., a geometric plane), the term “substantially 45 degrees” encompasses the object being positioned at an angle 45 degrees (45°) relative to the other object or plane and more broadly encompasses a meaning where the object is positioned and/or oriented relative to the other object or plane at an absolute angle of no more than five degrees (5°) from 45 degrees (45°). For example, a pylon that is positioned and/or oriented at an angle substantially 45 degrees from a horizontal plane and a vertical plane is positioned and/or oriented relative to the horizontal plane and the vertical plane at an absolute angle of no more than five degrees (5°) from 45 degrees (45°) (i.e., at an angle within a range of 40 degrees (40°) to 50 degrees (50°)). Further, as used herein in the context of describing a relative distance from a first object to a second object and a third object, the term “approximately equidistant” encompasses the term equidistant and more broadly encompasses a meaning where a first distance between the first object and the second object is within 10% of a second distance between the first object and the third object. For example, a first object that is approximately equidistant from a second object and a third object encompasses a first distance from the first object to the second object that has a value within a range of +/−10% of a value of a second distance from the first object to the third object.

As used herein, the term “central structural section” refers to a load carrying portion of a fuselage. The “central structural section” refers to a portion of the fuselage to which trusses or engine pylons couple for support. The “central structural section” is a protrusion positioned on a lower portion of the fuselage (e.g., during ground and/or cruise operations). Accordingly, the “central structural section” is typically positioned below a passenger compartment and defines a portion of the fuselage that has an increased (e.g., a maximum) cross-sectional area along a direction normal to a forward-to-aft direction. The “central structural section” can correspond to a same location on the fuselage as a belly fairing, which serves to reduce aerodynamic drag and improve the overall efficiency of the aircraft by smoothing the airflow around the fuselage, particularly in an area that includes a protrusion. However, it should be understood that the “central structural section” has more structural capability than a typical belly fairing such that the “central structural section” is able to carry loads transferred from the trusses or engine to the fuselage.

As used herein, the term “pylon” refers to a structural component which couples an aircraft engine to a body of the aircraft, such as the central structural section or a truss in the context of this disclosure. Specifically, the “pylon” supports a load of the aircraft engine and/or distributes the load to another structure of the aircraft, such as the central structural section or the truss. A pylon includes a main body, often referred to as a strut, which is a streamlined, elongated structure designed to minimize aerodynamic drag. The main body of the pylon is typically shaped like a flattened, tapered airfoil to reduce resistance as the aircraft moves through the air. For instance, the pylon can be covered with smooth, aerodynamic surfaces that reduce drag and protect internal components from the external environment. The pylon also includes mounts (e.g., mounting ends) that can be reinforced to handle static and dynamic forces generated by a weight, a thrust, and/or an aerodynamic load of the engine. The mounts are designed to securely hold the engine while allowing for some flexibility to absorb vibrations and thermal expansion. The pylon can also house internal components, such as fuel lines and/or hydraulic wiring, that support the operations of the engine. The pylon can also include structural reinforcements, such as ribs, spars, and/or stiffeners, to help the pylon withstand forces encountered during operation of the aircraft.

Commercial aircraft typically include a fuselage, wings extending from the fuselage, and engines mounted to the wings. However, enabling the wings to support the engines can limit the wingspan and require an increased wing thickness or chord (e.g., a length of the wing in the forward-to-aft direction), which results in a reduced aspect ratio that, in turn, necessitates greater power to produce lift. In recent years, exploration of aircraft that utilize truss-braced wings has increased. In such aircraft, the wings are supported by trusses that extend from the fuselage and are positioned below the wings. The support provided by the trusses enables the wings to be longer (e.g., have a longer wingspan) and thinner (e.g., in the forward-to-aft direction), which increases the aspect ratio of the wings and enables lift to be produced with less power.

However, in such aircraft, the engines are still coupled to the wings such that, while the trusses help support the wings, the wings still have to be structured to help support the engine. Additionally, in mounting the engines, the wings also have to house systems associated with the engine, such as fuel tanks and/or conduits, electrical lines, and/or other fluid conduits that support the operations of the aircraft and/or the engines. Moreover, as the wings are typically mounted to a central structural section of the fuselage, which is a stronger structural section of the fuselage that supports the landing gear, the fuselage in such truss-braced aircraft needs two such stronger structural sections—one from which the trusses extend and another from which the wings extend. In turn, the additional structural section can increase a size and/or weight of the aircraft and/or reduce cabin space for passengers and/or cargo. As such, the aspect ratio and/or a minimum weight of the wings in truss-braced wing aircraft still remains limited.

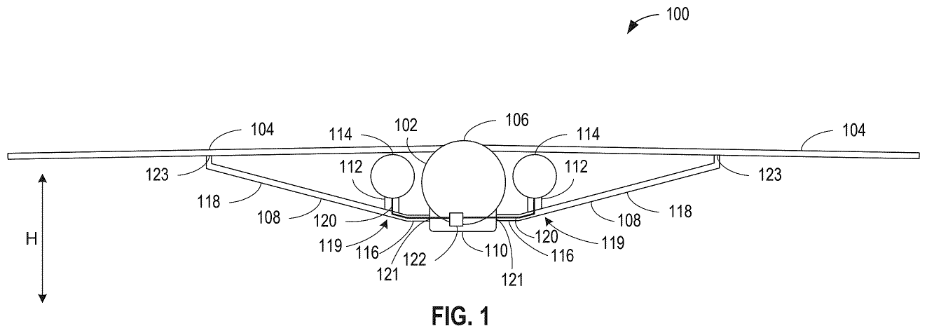

Examples disclosed herein provide example truss-braced wing aircraft engine mountings and associated systems that enable the aspect ratio of the wing to be increased and/or the weight of the wing to be reduced for improved flight efficiency (e.g., fuel efficiency, power efficiency, etc.). Turning now to the drawings, FIG. 1 is a schematic representation of an example aircraft 100 in accordance with examples disclosed herein. The aircraft 100 includes a fuselage 102, wings 104 extending from an upper portion 106 of the fuselage 102, and trusses 108 extending from a central structural section 110 (e.g., a lower portion, a stronger structural section, a landing gear housing section) of the fuselage 102. The aircraft 100 also includes pylons 112 that couple engines 114 to the trusses 108. The engines 114 can be ducted or unducted (e.g., open fan).

In the illustrated example of FIG. 1, the trusses 108 include horizontal portions 116 that extend from the central structural section 110 and angled portions 118 that extend from the horizontal portions 116 further from the fuselage 102 and upwards towards the wings 104. In this example, the pylons 112 are spaced from the horizontal portions 116 and are coupled directly to the angled portions 118 of the trusses 108 to provide space between the engines 114 (e.g., heat and/or noise produced by the engines 114) and the fuselage 102. Specifically, the angled portions 118 include first portions positioned on first sides of the pylons 112 and second portions on positioned on second sides of the pylons 112 opposite the first sides.

In the illustrated example of FIG. 1, the pylons 112 are coupled to lower portions 119 of the trusses 108. As used herein, the “lower portions” of the trusses 108 extend from (i) first ends 121 of the trusses 108 that couple to the central structural section 110 to (ii) a portion of the trusses 108 defined at a height (e.g., a distance in a height direction H, a distance in a direction normal to a forward-to-aft direction defined by the aircraft 100) less than or equal to half (50%) of a distance from the first ends 121 of the trusses 108 to second ends 123 of the trusses 108 that couple to the wings 104 in the height direction H. For example, when there is a distance between the first ends 121 and the second ends 123 of the trusses 108 in the height direction H is 30 meters, the lower portions 119 of the trusses 108 can extend from the first ends 121 to a portion of the trusses 108 that is separated from the first ends 121 by a distance of less than or equal to 15 meters (e.g., less than or equal to half of 30 meters) in the height direction H. In some examples, the lower portions 119 of the trusses 108 span from (i) the first ends 121 of the trusses to (ii) a portion of the trusses 108 defined at a distance less than or equal to a third (33.3%) of the distance from the first ends 121 to the second ends 123 in the height direction H. In some examples, the lower portions 119 of the trusses 108 span from (i) the first ends 121 of the trusses to (ii) a portion of the trusses 108 defined at a distance less than or equal to a quarter (25%) of the distance from the first ends 121 to the second ends 123 in the height direction H.

In the illustrated example of FIG. 1, the engines 114 are positioned approximately equidistant from the wings 104 and the trusses 108 in the height direction H. Specifically, a portion of the engine 114 that defines a maximum diameter of the engine 114 in a direction parallel to the height direction H is positioned approximately a same distance from an upper surface of the truss 108 that is aligned with the portion of the engines 114 in the height direction H and a lower surface of the wing 104 that is aligned with the portion of the engine 114 in the height direction H.

In some other examples, the engines 114 are not positioned approximately equidistant from the wings 104 and the trusses 108. In such examples, coupling the engines 114 to the lower portions 119 of the trusses 108 prevents the engines 114 from blowing the fluid flow produced by the engines 114 (e.g., airflow driven by a fan of the engines 114, exhaust gases) against the wings 104 and the trusses 108. That is, the wings 104 and the trusses are not in a pathway of the fluid flow produced by the engines 114. Additionally, in such examples, coupling the engines 114 to the lower portions 119 of the trusses 108 prevents the engines 114 from interfering with moving parts (e.g., slats) of the wings 104 and prevents the engines 114 from producing a gully between a nacelle and the lower surface of the wing 104 that is too short and creates undesirable aero interactions.

In the illustrated example of FIG. 1, mounting the engines 114 to the trusses 108 reduces a load that the wings 104 and the upper portion 106 of the fuselage 102 are structured to support. As such, a weight of the wings is reduced and an aspect ratio of the wings 104 is increased to improve lift provided by the wings 104, to reduce drag and, thus, improve flight characteristics and a fuel efficiency of the aircraft 100. Further, a structural strength necessitated by the upper portion 106 of the fuselage 102 is reduced, which enables the fuselage 102 to have a reduced weight, improved aerodynamics along the upper portion 106, and/or more cargo space.

In the illustrated example of FIG. 1, the aircraft 100 also includes at least one conduit 120 (e.g., an electrical line, a fluid line, etc.) to convey (e.g., carry, deliver, etc.) a fluid and/or electricity between the fuselage 102 and the engine 114. Specifically, a node 122 for the fluid and/or electricity is positioned in the central structural section 110 of the fuselage, and the engine 114 defines another node for the fluid and/or electricity. As such, the conduit 120 is positioned in and extends from the central structural section 110 of the fuselage 102 to the truss 108, the pylon 112, and, in turn, the engine 114. Positioning the conduit 120 in the truss 108, rather than the wing 104, reduces systems and/or structures housed in the wing 104, which further enables the aspect ratio of the wings 104 to increase and/or the weight of the wings to decrease.

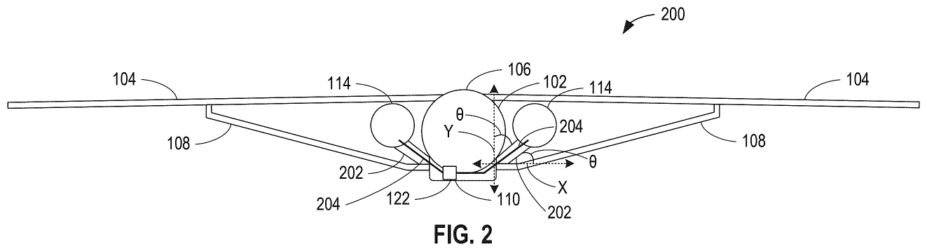

FIG. 2 is a schematic representation of another example aircraft 200 in accordance with examples disclosed herein. In the illustrated example of FIG. 2, the aircraft 200 includes the fuselage 102, the wings 104 extending from the upper portion 106 of the fuselage 102, the trusses 108 extending from the central structural section 110 to support the wings 104, and the node 122 for the fluid and/or electricity in the central structural section 110. In FIG. 2, the aircraft 200 includes pylons 202 that couple the engines 114 to the fuselage 102. Specifically, the pylons 202 directly couple to the central structural section 110 of the fuselage 102.

In the illustrated example of FIG. 2, the pylons 202 are positioned at an angle θ substantially 45 degrees (°) from a horizontal plane X and a vertical plane Y. The angle θ enables the engines 114 to be separated from the fuselage 106 by a distance that prevents or otherwise minimizes aero interaction associated with the fuselage 106 from affecting an intake of the engines 114. As such, the angle θ enables the engines 114 to encounter a more uniform flow intake to improve engine performance. Additionally, the angle θ enables the engines 114 to be separated from the wings 104 by a distance that prevents the engines 114 from blowing the fluid flow produced by the engines 114 (e.g., airflow driven by a fan of the engines 114, exhaust gases) against the wings 104. Similarly, the angle θ enables the engines 114 to be separated from the trusses 108 by a distance that prevents the engines 114 from blowing the fluid flow produced by the engines 114 against the trusses 108.

Advantageously, coupling the pylons 202 directly to the central structural section 110 reduces systems and/or structures that the trusses 108 house as at least one conduit 204 (e.g., the conduit 120, an electrical line, a fluid line, etc.) to convey (e.g., carry) a fluid and/or electricity between the fuselage 102 and the engine 114 can extend from node 122 in the central structural section 110 to the engine 114 via solely the pylon 202. As such, in addition to reducing a weight and increasing an aspect ratio of the wings 104, a size and/or weight of the truss 108 can be reduced to improve lift provided by the truss 108 and/or fuel efficiency.

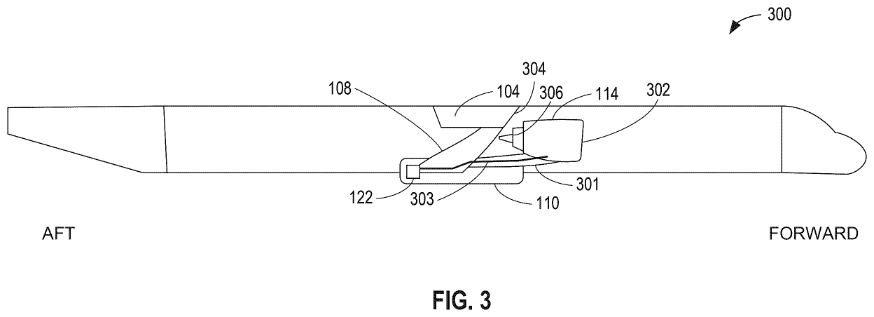

FIG. 3 is a side-view of an example aircraft 300 in accordance with examples disclosed herein. Specifically, the aircraft 300 of FIG. 3 can correspond to the aircraft 100 of FIG. 1 and/or the aircraft 200 of FIG. 2. As such, in FIG. 3, a pylon 301 of the aircraft 300 can be coupled to the truss 108, as in the aircraft 100 and the pylon 112 of FIG. 1, or the central structural section 110, as in the aircraft 200 and the pylon 202 of FIG. 2. When the pylon 301 is coupled to the truss 108, as in the aircraft 100 of FIG. 1, at least one conduit 303 (e.g., the conduit 120 of FIG. 1, the conduit 204 of FIG. 2) extends from the node 122 in the central structural section 110 to the truss 108, the pylon 301, and, in turn, the engine 114. When the pylon 301 is coupled to the central structural section 110, as in the aircraft 200 of FIG. 2, the conduit 303 extends from the central structural section 110 directly to the pylon 301.

In the illustrated example of FIG. 3, the engine 114 includes an inlet 302 positioned forward of a leading edge 304 of the wing 104. As such, the inlet 302 encounters a more uniform flow intake than if the inlet 302 were positioned downstream of the leading edge 304 such that the airflow interruption caused by the wing 104 would create turbulence in the flow intake encountered by the inlet 302. In some examples, an exhaust section 306 of the engine 114 is positioned forward of the leading edge 304 or forward of a portion of the leading edge 304 that is aligned with the engine 114 in the forward-to-aft direction to minimize or otherwise reduce interference with airflow encountered by pressure sides of the wings 104.

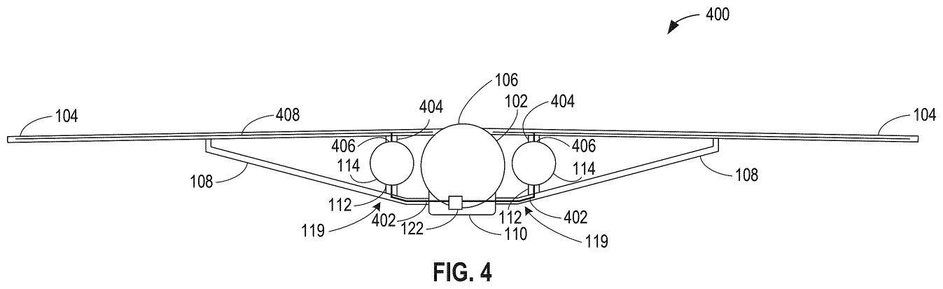

FIG. 4 is a schematic representation of another example aircraft 400 in accordance with examples disclosed herein. In the illustrated example of FIG. 4, the aircraft 400 includes the fuselage 102, the wings 104 extending from the upper portion 106 of the fuselage 102, the trusses 108 extending from the central structural section 110 to support the wings 104, the node 122 for the fluid and/or electricity in the central structural section 110, and the pylons 112 that couple directly to the trusses 108 to support the engines 114. In some examples, the aircraft 400 includes the pylons 202 of FIG. 2, which couple directly to the central structural section 110 instead of directly to the trusses 108 (e.g., with the pylons 112). The pylons 112 couple to lower portions 402 of the engines 114. In the illustrated example of FIG. 4, the aircraft 400 includes housings 404 that couple upper portions 406 of the engines 114 to the wings 104.

In some examples, the housings 404 serve as a second, upper pylon to help support and/or stiffen a position of the engine 114. In the illustrated example of FIG. 4, the pylons 112 serve as a primary support structure for the engines 114 and support a first portion of a load of the engines 114 in compression. On the other hand, the housings 404 can serve as a secondary support structure and support a second portion of the load of the engines 114 in tension. The housings 404 can include a main body similar to that of the pylons 112 but with a reduced size, weight, and/or structural reinforcements (e.g., ribs, spars, stiffeners, etc.) to minimize or otherwise reduce drag and/or fuel consumption that arises as a result of including the housings 404. In some examples, the pylons 112 and the housings 404 are directly connected and intersect at or proximate nacelles of the engines 114. For example, the pylons 112 and the housings 404 can be positioned closer to the fuselage 102 than exhaust sections (e.g., the exhaust section 306 of FIG. 3) of the engines 114.

In the illustrated example of FIG. 4, the aircraft 400 also includes at least one conduit 408 (e.g., the conduit 120 of FIG. 1, the conduit 204 of FIG. 2, an electrical line, a fluid line, etc.) to convey (e.g., carry) a fluid and/or electricity between the fuselage 102, the engines 114, and the wings 104. Specifically, the housing 404 enables the conduit 408 to extend from the engine 114 or the pylon 112 to the wing 104 positioned above the engine 114. For example, the conduit 408 can carry electrical wiring and/or anti-ice fluid (e.g., anti-ice or heating air) from the fuselage 102 and/or the engine 114 to the wings 104 that utilize the corresponding electricity and/or anti-ice fluid. As a result, portions of the trusses 108 positioned further from the fuselage 102 than the pylons 112 do not house conduits for systems not utilized by the trusses 108 such that a size and/or shape of the portions of the trusses 108 can be configured solely for support of the wings 104 and aerodynamics without additional space and/or aerodynamically inefficient contour needed for the conduit 408. Additionally, the upper portion 106 of the fuselage 102 remains free of housing systems and/or structures associated with conveyance of fluid and/or electricity throughout the aircraft 400. Further, the wings 104 remain free of housing systems and/or structures associated with conveyance of fluid and/or electricity not utilized by the wings 104.

Although shown in connection with the pylon 112 of FIG. 1, it should be understood that the housings 404 and the conduit 408 can be utilized in conjunction with the pylons 202 of FIG. 2 that couple directly to the central structural section 110.

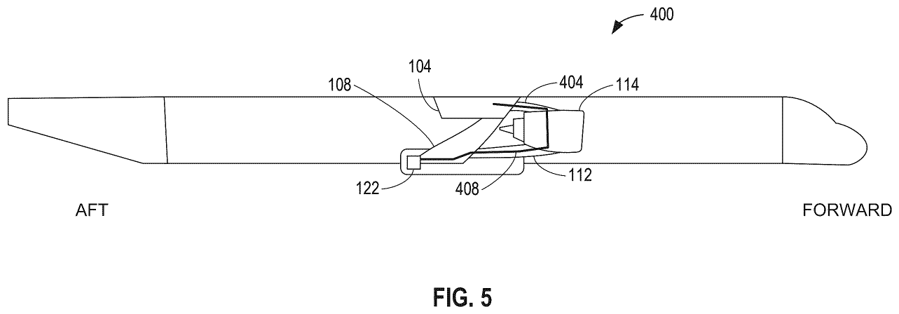

FIG. 5 is a side-view of the example aircraft 400 of FIG. 4. In the illustrated example of FIG. 5, the conduit 408 extends from the node 122, to the trusses 108, the pylons 112, the engines 114, the housings 404, and, in turn, the wings 104. As mentioned above, in some examples, the conduit 408 extends directly from the node 122 to the pylons 112, the engines 114, the housings 404, and the wings 104.

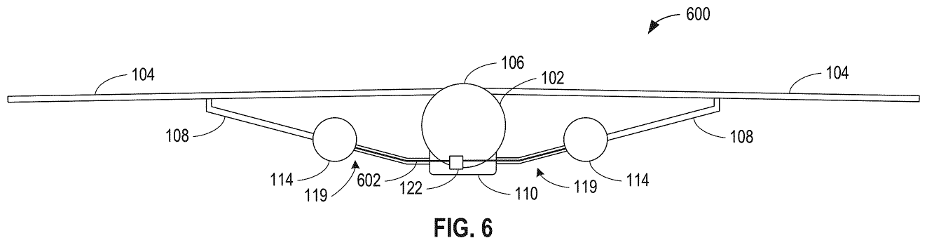

FIG. 6 is a schematic representation of another example aircraft 600 in accordance with examples disclosed herein. In the illustrated example of FIG. 6, the aircraft 600 includes the fuselage 102, the wings 104 extending from the upper portion 106 of the fuselage 102, the trusses 108 extending from the central structural section 110 to support the wings 104, and the node 122 for fluid and/or electricity in the central structural section 110. In the illustrated example of FIG. 6, the engines 114 couple directly to the trusses 108. For example, nacelles of the engines 114 can contact and/or enmesh with the trusses 108. As such, the aircraft 600 avoids utilization of pylons (e.g., the pylons 112, the pylons 202 of FIG. 2, the housings 404 of FIGS. 4-5) to support the engines 114, which can help reduce a weight of the aircraft. In this example, the engines 114 couple directly to the angled portions 118 of the trusses 108 to space the engines 114 from the fuselage 102.

In FIG. 6, the aircraft 600 includes at least one conduit 602 (e.g., the conduit 120 of FIG. 1, the conduit 204 of FIG. 2, the conduit 408 of FIG. 4, an electrical line, a fluid line, etc.) to convey (e.g., carry) a fluid and/or electricity between the fuselage 102 and the engine 114. In FIG. 6, the conduit 602 extends from the node 122 in the central structural section 110, to the trusses 108, and, in turn, the engines 114. In some examples, the conduit 602 continues through the nacelle of the engines 114 to a portion of the trusses 108 further from the fuselage 102 than the engines 114 to convey (e.g., carry) the fluid and/or electricity to the wings 104. In such examples, the aircraft 600 enables the upper portion 106 of the fuselage 102 to remain free of housing systems and/or structures associated with conveyance of fluid and/or electricity.

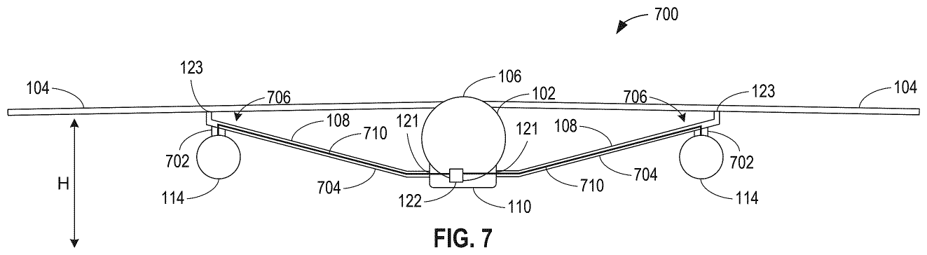

FIG. 7 is a schematic representation of another example aircraft 700 in accordance with examples disclosed herein. In the illustrated example of FIG. 7, the aircraft 700 includes the fuselage 102, the wings 104 extending from the upper portion 106 of the fuselage 102, the trusses 108 extending from the central structural section 110 to support the wings 104, and the node 122 for fluid and/or electricity in the central structural section 110. In the illustrated example of FIG. 7, the aircraft 700 also includes pylons 702 to couple the engines 114 to the trusses 108. Specifically, the pylons 702 extend from lower surfaces 704 of the trusses 108, and the engines 114 are positioned below the trusses 108. As such, the pylons 702 support the engines 114 in tension as opposed to compression as is the case with the pylons 112, 202 of FIGS. 1-5. Moreover, the pylons 702 are positioned between the engines 114 and the wings 104 in the height direction H. Further, the pylons 702 extend from upper portions 706 of the trusses 108. That is, the pylons are positioned closer to the second end 123 (e.g., a wing attachment end) than the first end 121 (e.g., in the height direction H and/or relative to a length of the trusses 108 between the ends 121, 123) to space the engines 114 from a ground surface (e.g., a riding surface for landing gear of the aircraft 700) as well as the fuselage 102. As used herein, the “upper portions” of the trusses 108 extend from (i) the second ends 123 of the trusses 108 that couple to the wings 104 to (ii) a portion of the trusses 108 defined at a height (e.g., a distance in the height direction H, a distance in a direction normal to a forward-to-aft direction defined by the aircraft 100) less than or equal to half (50%) of a distance from the second ends 123 of the trusses 108 to the first ends 121 in the height direction H.

In the illustrated example of FIG. 7, the aircraft 700 also includes at least one conduit 710 (e.g., the conduit 120 of FIG. 1, the conduit 204 of FIG. 2, the conduit 408 of FIG. 4, the conduit 602 of FIG. 6, an electrical line, a fluid line, etc.) to convey (e.g., carry) a fluid and/or electricity between the fuselage 102 and the engine 114. The conduit 710 extends from the node 122 in the central structural section 110, to the trusses 108, the pylons 702, and, in turn, the engines 114. In some examples, the conduit 710 continues in the trusses 108 past the pylons 702 to the wings 104 to convey (e.g., carry) the fluid and/or electricity to the wings 104. In such examples, the aircraft 700 enables the upper portion 106 of the fuselage 102 to remain free of housing systems and/or structures associated with conveyance of fluid and/or electricity.

Although each example aircraft disclosed above has certain features, it should be understood that it is not necessary for a particular feature of one example aircraft to be used exclusively with that example. Instead, any of the features described above and/or depicted in the drawings can be combined with any of the examples, in addition to or in substitution for any of the other features of those examples. Features of one example are not mutually exclusive to features of another example. Instead, the scope of this disclosure encompasses any combination of any of the features.

From the foregoing, it will be appreciated that example truss-braced wing aircraft engine mountings have been disclosed that enable the aspect ratio of the wing to be increased and/or the weight of the wing to be reduced for improved flight efficiency (e.g., fuel efficiency, power efficiency, etc.). Further, the example truss-braced wing aircraft engine mountings enable efficient electrical and/or fluid conduits for the aircraft that minimize or otherwise reduce a weight and/or size of components, such as the wings and/or trusses. Additionally, the example truss-braced wing aircraft engine mountings enable an upper portion of a fuselage of the aircraft to remain free of housing systems and/or structures associated with conveyance of fluid and/or electricity to enable a contour of the upper portion of the fuselage to be configured for aerodynamics and increase cargo space in the fuselage.

Example truss-braced wing aircraft engine mountings are disclosed herein. Further examples and combinations thereof include the following:

An aircraft comprising a fuselage including a central structural section, a wing extending from the fuselage, a truss extending from the central structural section and coupled to the wing, a pylon coupled to the central structural section, wherein the pylon is positioned at an angle substantially 45 degrees from a horizontal plane and a vertical plane, and an engine coupled to the pylon.

An aircraft comprising a fuselage including a central structural section, a wing coupled to the fuselage, a truss coupled to the central structural section of the fuselage and the wing, wherein the truss includes a horizontal portion that extends from the fuselage and an angled portion that extends from the horizontal portion towards the wing, a pylon coupled directly to the angled portion of the truss, and an engine coupled to the pylon.

An aircraft comprising a fuselage including a central structural section, a wing coupled to the fuselage, a truss coupled to the central structural section of the fuselage and the wing, and an engine coupled to the central structural section or the truss, wherein the engine is positioned approximately equidistant from the wing and the truss in a height direction defined by the aircraft.

An aircraft comprising a fuselage including a central structural section, a wing extending from the fuselage, a truss extending from the central structural section and coupled to the wing, a pylon coupled to the truss or the central structural section, and an engine coupled to the pylon.

An aircraft comprising a fuselage including a central structural section, a wing extending from the fuselage, a truss extending from the central structural section and coupled to the wing, a pylon coupled to the central structural section, and an engine coupled to the pylon.

The aircraft of any preceding clause, further including a conduit to carry at least one of a fluid or electricity between the fuselage and the engine.

The aircraft of any preceding clause, wherein the conduit is positioned in the truss.

The aircraft of any preceding clause, wherein the conduit extends from the engine to the wing positioned above the engine to deliver the fluid or the electricity to the wing.

The aircraft of any preceding clause, wherein an inlet of the engine is positioned forward of the wing.

The aircraft of any preceding clause, wherein the truss is positioned between the engine and the wing.

The aircraft of any preceding clause, wherein the pylon couples a first portion of the engine to the truss or the fuselage, further including a housing to couple a second portion of the engine to the wing.

The aircraft of any preceding clause, wherein the truss includes a horizontal portion that extends from the fuselage and an angled portion that extends from the horizontal portion, wherein the pylon is coupled to the angled portion, and wherein the angled portion is positioned on a first side of the pylon and a second side of the pylon opposite the first side.

An aircraft comprising a fuselage including a central structural section, a wing coupled to the fuselage, a truss coupled to the central structural section of the fuselage and the wing, a pylon coupled directly to the central structural section or the truss, and an engine coupled to the pylon.

An aircraft comprising a fuselage including a central structural section, a wing coupled to the fuselage, a truss coupled to the central structural section of the fuselage and the wing, a pylon coupled directly to the truss, and an engine coupled to the pylon.

The aircraft of any preceding clause, wherein the pylon is coupled directly to the central structural section.

The aircraft of any preceding clause, further including a conduit to carry a fluid or electricity between the central structural section of the fuselage and the engine.

The aircraft of any preceding clause, wherein the conduit is positioned in the truss.

The aircraft of any preceding clause, wherein the conduit extends from the engine to the wing positioned above the engine to deliver the fluid or the electricity to the wing.

The aircraft of any preceding clause, wherein the conduit carries an anti-ice fluid from the engine to the wing.

The aircraft of any preceding clause, wherein the engine is positioned between a portion of the truss and the wing.

The aircraft of any preceding clause, wherein an exhaust section of the engine is positioned forward of the wing.

The aircraft of any preceding clause, further including a housing that couples the engine directly to the wing.

The aircraft of any preceding clause, wherein the pylon is coupled directly to the truss, and wherein the engine is positioned below the truss.

An aircraft comprising a fuselage including a central structural section, a wing coupled to the fuselage, a truss coupled to the central structural section of the fuselage and the wing, and an engine coupled to the central structural section or the truss.

The aircraft of any preceding clause, further including a conduit to convey at least one of a fluid or electricity between the fuselage and the engine, the conduit positioned in the truss.

The aircraft of any preceding clause, wherein the conduit is coupled to a node positioned in the central structural section.

The aircraft of any preceding clause, wherein the pylon couples a first portion of the engine to the fuselage, further including a housing to couple a second portion of the engine to the wing.

The aircraft of any preceding clause, wherein the truss includes a horizontal portion that extends from the fuselage and an angled portion that extends from the horizontal portion, wherein the pylon is coupled to the angled portion, and wherein the angled portion is positioned on a first side of the pylon and a second side of the pylon opposite the first side.

The aircraft of any preceding clause, wherein the pylon is coupled to a lower portion of the truss.

The aircraft of any preceding clause, wherein the truss is positioned between the engine and the wing in a height direction defined by the aircraft.

An aircraft comprising a fuselage, a wing coupled to the fuselage, a truss coupled to the central structural section of the fuselage and the wing, and an engine directly coupled to the truss.

The aircraft of any preceding clause, wherein the engine includes a nacelle that enmeshes with the truss.

The aircraft of any preceding clause, wherein the truss includes a horizontal portion that extends from the fuselage and an angled portion that extends from the horizontal portion, wherein the pylon is coupled to the angled portion, wherein the angled portion is positioned on a first side of the pylon and a second side of the pylon opposite the first side, and wherein the pylon is coupled to a lower portion of the truss.

The aircraft of any preceding clause, wherein the lower portion of the truss extends from a first end of the truss that couples to the central structural section to (ii) a portion of the trusses 108 defined at a height less than or equal to half of a distance from the first end of the truss to a second end of the truss that couples to the wing in a height direction defined by the aircraft.

The aircraft of any preceding clause, wherein the lower portion of the truss extends from a first end of the truss that couples to the central structural section to (ii) a portion of the trusses 108 defined at a height less than or equal to a third of a distance from the first end of the truss to a second end of the truss that couples to the wing in a height direction defined by the aircraft.

The aircraft of any preceding clause, wherein the lower portion of the truss extends from a first end of the truss that couples to the central structural section to (ii) a portion of the trusses 108 defined at a height less than or equal to quarter of a distance from the first end of the truss to a second end of the truss that couples to the wing in a height direction defined by the aircraft.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An aircraft comprising:
a fuselage including a central structural section;
a wing extending from the fuselage;
a truss extending from the central structural section and coupled to the wing;
a pylon coupled to the central structural section, wherein the pylon is positioned at an angle substantially 45 degrees from a horizontal plane and a vertical plane; and
an engine coupled to the pylon.

2. The aircraft of claim 1, further including a conduit to carry at least one of a fluid or electricity between the fuselage and the engine.

3. The aircraft of claim 2, wherein the conduit extends from the engine to the wing positioned above the engine to deliver the fluid or the electricity to the wing.

4. The aircraft of claim 1, wherein an inlet of the engine is positioned forward of the wing.

5. An aircraft comprising:
a fuselage including a central structural section;
a wing coupled to the fuselage;
a truss coupled to the central structural section of the fuselage and the wing, a pylon coupled directly to the central structural section; and an engine coupled to the pylon.

6. The aircraft of claim 5, further including a conduit to carry a fluid or electricity between the central structural section of the fuselage and the engine.

7. The aircraft of claim 6, wherein the conduit is positioned in the pylon.

8. The aircraft of claim 6, wherein the conduit extends from a node in the central structural section to the engine via solely the pylon.

9. (canceled)

10. The aircraft of claim 5, wherein the engine is positioned between a portion of the truss and the wing.

11. The aircraft of claim 5, wherein an exhaust section of the engine is positioned forward of the wing.

12-17. (canceled)

18. An aircraft comprising:
a fuselage including a central structural section;
a wing coupled to the fuselage;
a truss coupled to the central structural section of the fuselage and the wing; and
an engine coupled to the central structural section, wherein the engine is positioned approximately equidistant from the wing and the truss in a height direction defined by the aircraft.

19. The aircraft of claim 18, further including a conduit to convey at least one of a fluid or electricity between the fuselage and the engine.

20. (canceled)

21. The aircraft of claim 2, wherein the conduit extends from a node in the central structural section to the engine via solely the pylon.

22. The aircraft of claim 1, wherein an exhaust section of the engine is positioned forward of a leading edge of the wing.

23. The aircraft of claim 1, wherein the engine is positioned between a portion of the truss and the wing in a height direction defined by the aircraft.

24. The aircraft of claim 23, wherein the engine is positioned approximately equidistant from the wing and the truss in the height direction.

25. The aircraft of claim 5, wherein the pylon is positioned at an angle substantially 45 degrees from a horizontal plane and a vertical plane.

26. The aircraft of claim 5, wherein the engine is positioned approximately equidistant from the wing and the truss in a height direction defined by the aircraft.

27. The aircraft of claim 18, wherein the pylon is positioned at an angle substantially 45 degrees from a horizontal plane and a vertical plane.

28. The aircraft of claim 18, wherein an exhaust section of the engine is positioned forward of a leading edge of the wing.
